(19) United States
(12) Patent Application Publication
(10) Pub. No.: US 2026/0289918 A1
(43) Pub. Date: Sep. 24, 2026

(54) ADAPTIVE REPROJECTION IN SPLIT XR SYSTEMS

(71) Applicant: QUALCOMM Incorporated, San Diego, CA (US)

(72) Inventors: Simon Peter William BOOTH, San Diego, CA (US); Pawan Kumar BAHETI, San Diego, CA (US); Wesley James HOLLAND, Encinitas, CA (US); Rakesh Raju CHENNA MADHAVUNI, San Diego, CA (US); Kapil AHUJA, Bengaluru (IN)

(21) Appl. No.: 19/474,165

(22) PCT Filed: Apr. 23, 2024
(86) PCT No.: PCT/US2024/025834

§ 371 Date: Oct. 9, 2025

(30) Foreign Application Priority Data
May 12, 2023 (IN) 202341033488

(51) Int. Cl. G06T 19/00; G06F 3/01; H04N 13/106

(52) U.S. Cl. CPC G06T 19/006; G06F 3/012; H04N 13/106

(57) ABSTRACT

This disclosure provides systems, devices, apparatus, and methods, including computer programs encoded on storage media, for adaptive reprojection in split XR systems. A graphics processor may obtain an indication of at least one reprojection algorithm used at a wearable display device. The graphics processor may render, based on the indication of the at least one reprojection algorithm, content for the wearable display device. The graphics processor may transmit, for the wearable display device, the rendered content for the wearable display device.

### CROSS REFERENCE TO RELATED APPLICATION

This application claims the benefit of Indian Provisional Application No. 202341033488, entitled “ADAPTIVE REPROJECTION IN SPLIT XR SYSTEMS” and filed on May 12, 2023, which is expressly incorporated by reference herein in its entirety.

### TECHNICAL FIELD

The present disclosure relates generally to processing systems, and more particularly, to one or more techniques for graphics and/or display processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for reprojection in a split extended reality (XR) system may not take into account various factors at a remote device and/or a wearable display device. There is a need for improved techniques for reprojection in split XR systems.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus for graphics processing at a remote device are provided. The apparatus includes a memory; and a processor coupled to the memory and, based on information stored in the memory, the processor is configured to: obtain an indication of at least one reprojection algorithm used at a wearable display device; render, based on the indication of the at least one reprojection algorithm, content for the wearable display device; and transmit, for the wearable display device, the rendered content for the wearable display device.

In an aspect of the disclosure, a method, a computer-readable medium, and an apparatus for display processing at a wearable display device are provided. The apparatus includes a memory; and a processor coupled to the memory and, based on information stored in the memory, the processor is configured to: select at least one reprojection algorithm from amongst a plurality of reprojection algorithms based on a set of factors associated with at least one of a wearable display device or a remote device; transmit, for the remote device, an indication of the selected at least one reprojection algorithm; obtain, from the remote device and based on the selected at least one reprojection algorithm, rendered content; and execute the at least one reprojection algorithm on the rendered content.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example display framework including a display processor and a display in accordance with one or more techniques of this disclosure.

FIG. 4 is a diagram illustrating an example split augmented reality (AR) system in accordance with one or more techniques of this disclosure.

FIG. 5 is a diagram illustrating an example of reprojection algorithm selection factors in accordance with one or more techniques of this disclosure.

FIG. 6 is a diagram illustrating an example of an enhanced split AR system in accordance with one or more techniques of this disclosure.

FIG. 7 is a call flow diagram illustrating example communications between a wearable display device and a remote device in accordance with one or more techniques of this disclosure.

FIG. 8 is a flowchart of an example method of graphics processing in accordance with one or more techniques of this disclosure.

FIG. 9 is a flowchart of an example method of display processing in accordance with one or more techniques of this disclosure.

FIG. 10 is a flowchart of an example method of display processing in accordance with one or more techniques of this disclosure.

FIG. 11 is a flowchart of an example method of display processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processor or a GPU. The term “reprojection” may refer to a process of warping rendered frames (i.e., rendered content) based on latest available pose information. The term “reprojection algorithm” may refer to an algorithm that is associated with a number of different reprojections or timewarps (e.g., asynchronous reprojection, asynchronous timewarp, asynchronous spacewarp, motion smoothing, etc.). The term “pose information” may refer to information that is related to a head pose at a device (e.g., a six degree-of-freedom (6DOF) pose including a position (xyz)). The term “wearable display device” may refer to a device that is capable of being worn by a user to display content (e.g., a head device, a head mounted display (HMD), glasses, etc.). The term “workload” may refer to a workload that is processed at a graphics processor or a GPU (e.g., a vertex or pixel workload).

An extended reality (XR) system (e.g., an augmented reality (AR) system, a virtual reality (VR) system, a mixed reality (MR) system) may include a remote device (e.g., a phone, a tablet, a desktop computing device, a laptop computing device, a server, etc.) and a wearable display device (e.g., a head device, a head mounted display (HMD), glasses, etc.) that communicate over a wired or wireless connection, where the wearable display device may be worn on/over/around eye(s) of a user. The wearable display device may have less battery life and less computational power in comparison to battery life and computational power of the remote device. As such, rendering and other workloads may be offloaded to the remote device. For instance, the remote device may receive pose information (e.g., a six degree-of-freedom (6DOF) pose including position (xyz) and orientation (roll, pitch, yaw)) of the wearable display device and the remote device may render a frame of XR content (e.g., AR content, MR content, VR content, etc.) based on the pose information and the remote device may transmit the frame to the wearable display device.

A position and/or an orientation of the wearable display device may change between a time at which the pose information is transmitted by the wearable display device and a time at which the rendered frame of XR content is received by the wearable display device. The wearable display device may execute a reprojection algorithm (e.g., asynchronous reprojection, asynchronous timewarp, asynchronous spacewarp, motion smoothing, etc.) on the rendered frame of XR content in order to account for the change in the position and/or orientation of the wearable display device. The wearable display device may then present the reprojected rendered frame on display(s) (e.g., a left eye display and a right eye display) of the wearable display device. The wearable display device may be statically configured with reprojection algorithms, that is, the wearable display device may not take into account various factors (e.g., a temperature at the wearable display device, a concurrent workload at the remote device, etc.) at the wearable display device and/or the remote device when executing the reprojection algorithms. This may affect user experience. In an example, if a battery level of the wearable display device is low and the wearable display device executes a reprojection algorithm that consumes a relatively high amount of battery power in comparison to battery power consumed by other reprojection algorithms, usage time of the wearable display device may be impacted. In another example, if a relatively high amount of latency exists between the remote device and the wearable display device and the wearable display device executes a reprojection algorithm designed for low latency scenarios, the wearable display device may not display XR content in a manner in which the XR content is intended to be displayed.

Various technologies pertaining to adaptive reprojection in split XR systems are described herein. In an example, an apparatus (e.g., a remote device) obtains an indication of at least one reprojection algorithm used at a wearable display device. The apparatus (e.g., a remote device) renders, based on the indication of the at least one reprojection algorithm, content for the wearable display device. The apparatus (e.g., a remote device) transmits, for the wearable display device, the rendered content for the wearable display device. In another example, the apparatus (e.g., a wearable display device) selects select at least one reprojection algorithm from amongst a plurality of reprojection algorithms based on a set of factors associated with at least one of a wearable display device or a remote device. The apparatus (e.g., a wearable display device) transmits, for the remote device, an indication of the selected at least one reprojection algorithm. The apparatus (e.g., a wearable display device) obtains, from the remote device and based on the selected at least one reprojection algorithm, rendered content. The apparatus (e.g., a wearable display device) executes the at least one reprojection algorithm on the rendered content.

Vis-à-vis the above described technologies, a remote device may render content in a manner that leverages the at least one reprojection algorithm used at a wearable display device. As a result, battery consumption and/or computational workloads at the wearable display device may be reduced when the wearable display device executes the at least one reprojection algorithm on the rendered content. Furthermore, by selecting at least one reprojection algorithm from amongst the plurality of reprojection algorithms based on the set of factors (as opposed to statically using the same reprojection algorithm(s)), battery consumption and/or computational workloads at the wearable display device may be reduced when executing the at least one reprojection algorithm on the rendered content.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

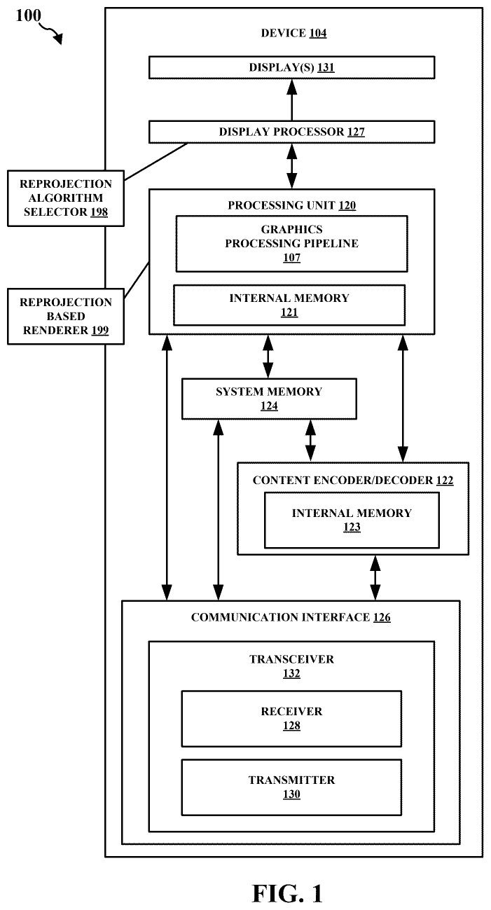

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 and/or the graphics processing pipeline 107 may include a reprojection based renderer 199 configured to obtain an indication of at least one reprojection algorithm used at a wearable display device; render, based on the indication of the at least one reprojection algorithm, content for the wearable display device; and transmit, for the wearable display device, the rendered content for the wearable display device. In certain aspects, the display processor 127 may include a reprojection algorithm selector 198 configured to select at least one reprojection algorithm from amongst a plurality of reprojection algorithms based on a set of factors associated with at least one of a wearable display device or a remote device; transmit, for the remote device, an indication of the selected at least one reprojection algorithm; obtain, from the remote device and based on the selected at least one reprojection algorithm, rendered content; and execute the at least one reprojection algorithm on the rendered content. Although the following description may be focused on wearable AR devices, the concepts presented herein may also be application to non-wearable AR devices, such as a vehicle that displays AR content on a windshield of the vehicle.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload (e.g., a vertex or pixel workload) in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

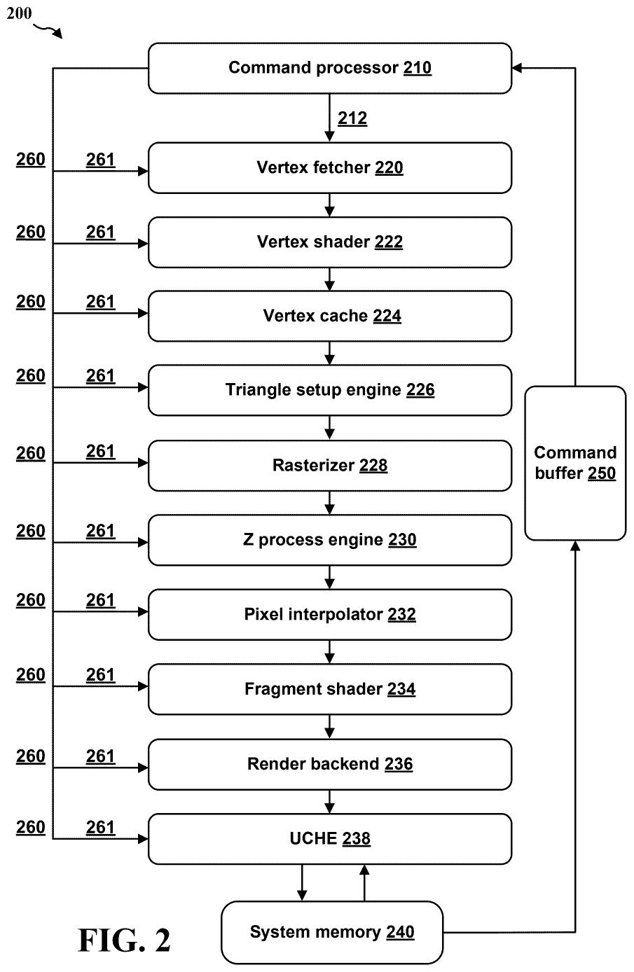

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

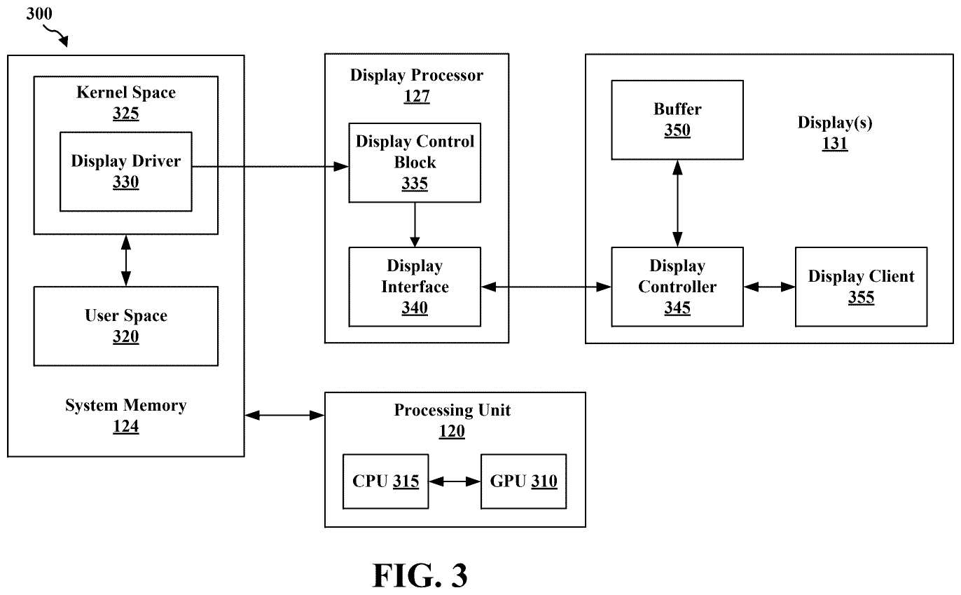

FIG. 3 is a block diagram 300 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120.

The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync, VSync, or VSYNC) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

A user may wear a display device in order to experienced extended reality (XR) content. XR may refer to a technology that blends aspects of a digital experience and the real world. XR may include augmented reality (AR), mixed reality (MR), and/or virtual reality (VR). In AR, AR objects may be superimposed on a real-world environment as perceived through the display device. In an example, AR content may be experienced through AR glasses that include a transparent or semi-transparent surface. An AR object may be projected onto the transparent or semi-transparent surface of the glasses as a user views an environment through the glasses. In general, the AR object may not be present in the real world and the user may not interact with the AR object. In MR, MR objects may be superimposed on a real-world environment as perceived through the display device and the user may interact with the MR objects. In some aspects, MR objects may include “video see through” with virtual content added. In an example, the user may “touch” a MR object being displayed to the user (i.e., the user may place a hand at a location in the real world where the MR object appears to be located from the perspective of the user), and the MR object may “move” based on the MR object being touched (i.e., a location of the MR object on a display may change). In general, MR content may be experienced through MR glasses (similar to AR glasses) worn by the user or through a head mounted display (HMD) worn by the user. The HMD may include a camera and one or more display panels. The HMD may capture an image of environment as perceived through the camera and display the image of the environment to the user with MR objects overlaid thereon. Unlike the transparent or semi-transparent surface of the AR/MR glasses, the one or more display panels of the HMD may not be transparent or semi-transparent. In VR, a user may experience a fully-immersive digital environment in which the real-world is blocked out. VR content may be experienced through a HMD.

An AR system may utilize a head pose (i.e., pose information, such as a 6DOF pose) of an AR headset (i.e., a wearable display device) and reprojection in order to render and display content to a user in a manner that is mapped to a world-locked location. Reprojection may refer to a wearable display device warping rendered frames (i.e., rendered content) received from a remote device based on latest available pose information of the wearable display device. Reprojection may also be referred to as late stage reprojection (LSR) or asynchronous reprojection. Reprojection may account for a change in location/orientation of the wearable display device between a time at which the frame is rendered at the remote device and a time at which the rendered frame is received at the wearable display device.

Stated differently, to display content, an AR system may utilize a predicted 6DOF pose of a head of a user to render content. Latency between a time of rendering and presentation on a display device (i.e., a wearable display device) may be accounted for via reprojection to account for a predicted head pose of a user of the display device. Approaches to pose prediction and reprojection may be associated with varying degrees of computational complexity to account for more or less pose prediction error and/or the nature of the content (e.g., XR content, such as AR content).

An AR system may be a split AR system including a head device (i.e., a wearable display device) and a remote device. Head devices may be power constrained in terms of battery life concerns and/or thermal dissipation. As such, in a split AR system, rendering and other workloads may be offloaded to device(s) (i.e., remote device(s)) in order to reduce a computational load on the head device. Remote device(s) may be connected to a head device through a physical (i.e., wired) or wireless connection (e.g., wireless local area network (WLAN), 5G New Radio (NR), etc.). Remote device(s) may be or include a local device (e.g., a phone, which may also be referred to as a “puck”) or a process running on a cloud server. A remote device used to render content in a split AR system may change dynamically during operation of an AR application associated with generating AR content. For instance, a render process may transfer from a phone (i.e., a local puck) to a cloud server based on WLAN service quality and/or cellular service quality. A connection type may also change dynamically during operation of the AR application. For instance, if a phone (i.e., a puck) is unplugged from a head device, the connection between the phone and head device may transition from a wired connection to a wireless connection.

AR systems may be designed to optimize tradeoffs between a quality of a user experience, including reprojection algorithm complexity, and power consumption at a headset device (i.e., a wearable display device). AR systems may typically have statically defined reprojection algorithms that may be designed for a range of expected content and motion-to-render-to-display latencies. This may impact a user experience for some applications in which latency between a remote device and a wearable display device is high and/or where power consumption is high for low latency scenarios.

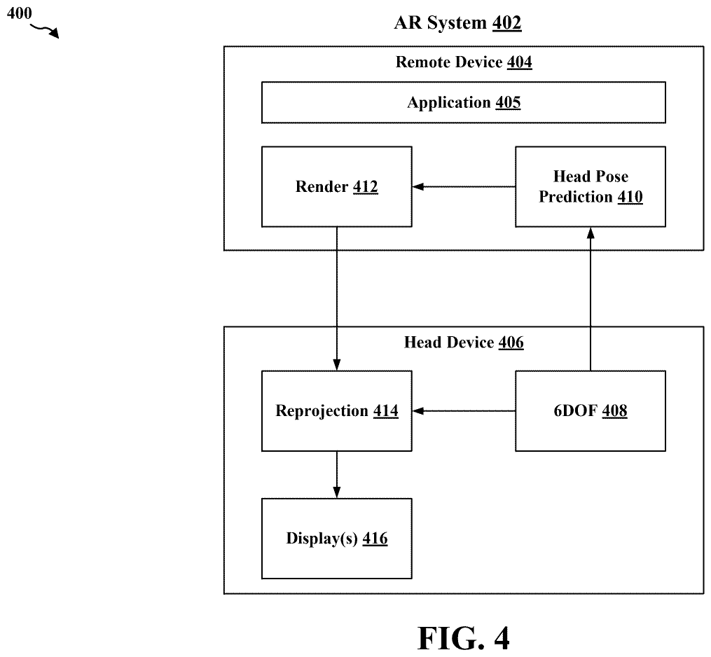

FIG. 4 is a diagram 400 illustrating an example split augmented reality (AR) system 402 in accordance with one or more techniques of this disclosure. The split AR system 402 may include a remote device 404 and a head device 406. In an example, the remote device 404 may be or include phone(s), such as smartphone(s), tablet(s), desktop computing device(s), laptop computing device(s), server(s), such as cloud servers, and/or gaming console(s). In an example, the head device 406 may be a head mounted display (HMD) or AR glasses. The remote device 404 and the head device 406 may be connected and may communicate via a wired connection (e.g., universal serial bus (USB)) or a wireless connection (e.g., WLAN, 5G NR, another cellular technology, etc.). In general, the remote device 404 may be configured to render AR content and transmit the AR content to the head device 406. In general, the head device 406 may be configured to receive rendered AR content, process the rendered AR content (explained in greater detail below), and present the processed rendered content on display(s). In one aspect, the head device 406 may include a first display and a second display. When the head device 406 is worn by a user, the first display and the second display may be located within several centimeters of a first eye of the user and a second eye of the user, respectively. The head device 406 may present first processed rendered content on the first display concurrently (or nearly concurrently) with presenting second processed rendered content on the second display, where the first processed rendered content may be viewed by the first eye and the second processed rendered content may be viewed by the second eye. In an example, when viewed by the user, the first processed rendered content and the second processed rendered content may be perceived to be an object present in an environment of the user. In an example, the remote device 404 may be the device 104. In another example, the head device 406 may be the device 104.

The remote device 404 may include an application 405. In an example, the application 405 may be an AR application configured to render AR content. The head device 406 may include a light-weight application corresponding to the application 405, where the light-weight application may be configured to perform a lesser amount of processing in comparison to an amount of processing performed by the application 405 due to limited processing capabilities of the head device 406.

The head device 406 may obtain pose information 408 (referred to as “6DOF” in FIG. 4) of the head device 406. The pose information 408 may include a current location (e.g., an xyz coordinate) and orientation (e.g., a roll, a pitch, and a yaw) of the head device 406 (and hence, a head of a user of the head device 406). In an example, the head device 406 may obtain the pose information 408 by way of an inertial measurement unit (IMU) of the head device 406. The head device 406 may transmit the pose information to the remote device 404. The head device 406 may also transmit additional information to the remote device 404, such as camera images captured by a camera of the head device 406, input by a user of the head device 406, a state of the light-weight application, etc.

The remote device 404 may perform a head pose prediction 410 based on the pose information, where the head pose prediction 410 is a prediction of a future location and orientation of the head device 406 (and hence, the head of the user of the head device 406). The remote device 404 may render 412 AR content (e.g., frame(s)) based on head pose prediction 410. The remote device 404 may also render 412 the AR content based on one or more of the camera images, the input by the user, the state of the light-weight application, a state of the application 405, data from other sources, etc. The remote device 404 may transmit the rendered AR content to the head device 406.

The head device 406 may perform a reprojection 414 on the rendered AR content, that is, the head device 406 may execute a reprojection algorithm on the rendered AR content. The reprojection algorithm may account for a change in location of the head device 406 between a time at which the pose information 408 was transmitted and a time at which the rendered AR content was received. The head device 406 may output the reprojected rendered AR content for display on display(s) 416. The head device 406 may execute the reprojection algorithm without taking into account factors at the remote device 404 and/or at the head device 406, which may affect user experience.

Although not depicted in FIG. 4, the remote device 404 and the head device 406 may include additional components. For instance, the remote device 404 and the head device 406 may each include processor(s), memory, data storage, communication devices (e.g., modems), batteries, buses, input devices, output devices, etc.

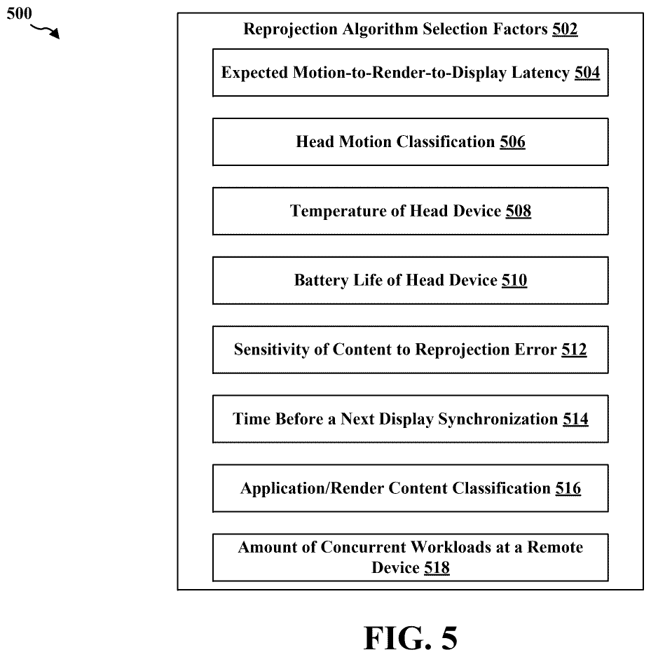

FIG. 5 is a diagram 500 illustrating an example of reprojection algorithm selection factors 502 in accordance with one or more techniques of this disclosure. As discussed herein, an AR system (e.g., a remote device and a wearable display device) may dynamically modulate a reprojection algorithm (or a complexity of a reprojection algorithm) based on the reprojection algorithm selection factors 502. Furthermore, as discussed herein, the AR system may dynamically modulate rendering of content on a remote device based on a reprojection algorithm used at the wearable display device (i.e., a head device). In an example, the remote device may render content, depth planes, layers, etc. with reduced or increased complexity based on the reprojection algorithm used at the wearable display device. In another example, the remote device may render frames at an increased or a decreased frame rate based on the reprojection algorithm used at the wearable display device. The reprojection algorithm selection factors 502 may be associated with a remote device and/or a wearable display device.

The reprojection algorithm selection factors 502 may include an expected motion-to-render-to-display latency 504. The expected motion-to-render-to-display latency 504 may account for a time period encompassing (1) a first time period for the wearable display device to obtain and transmit pose information, (2) a second time period for the remote device to render content (e.g., AR content), (3) a third time period for the remote device to transmit the rendered content, and (4) a fourth time period for the wearable display device to reproject and display the rendered content. The expected motion-to-render-to-display latency 504 may be computed by a remote device and/or a wearable display device.

The reprojection algorithm selection factors 502 may include a head motion classification 506, that is a classification of motion undergone by a head of the user (and hence a classification of motion undergone by the wearable display device). In one example, the head motion classification 506 may be fast or slow. In another example, the head motion classification 506 may be predictable or erratic. A wearable display device may determine the head motion classification 506 based on pose information of the wearable display device (e.g., first pose information obtained at a first time instance, second pose information obtained at a second time instance, etc.). The head motion classification 506 may also include an expected head pose prediction error.

The reprojection algorithm selection factors 502 may include a temperature of a head device 508 (i.e., thermal dissipation), that is, a temperature of a wearable display device. A head device may determine the temperature of the head device 508 via temperature sensor(s) of the head device.

The reprojection algorithm selection factors 502 may include a battery life of a head device 510, that is, a remaining battery level of a wearable display device or a capacity of a battery of the wearable display device when fully charged. A head device may determine the battery life of the head device 510 using battery sensor(s) of the head device.

The reprojection algorithm selection factors 502 may include a sensitivity of content to reprojection error 512. For instance, certain types of content may be more prone to reprojection error in comparison to other types of content. The sensitivity of the content to reprojection error 512 may be based on a classification of the content.

The reprojection algorithm selection factors 502 may include a time before a next display synchronization 514. In an example, the time before a next display synchronization may be a time before a next Vsync instance at one or more display(s) of a wearable display device.

The reprojection algorithm selection factors 502 may include an application/render content classification 516. The application/render content classification 516 may be determined by a remote device.

The reprojection algorithm selection factors 502 may include an amount of concurrent workloads at a remote device 518. The amount of concurrent workloads at the remote device 518 may be determined by a remote device and transmitted to a wearable display device.

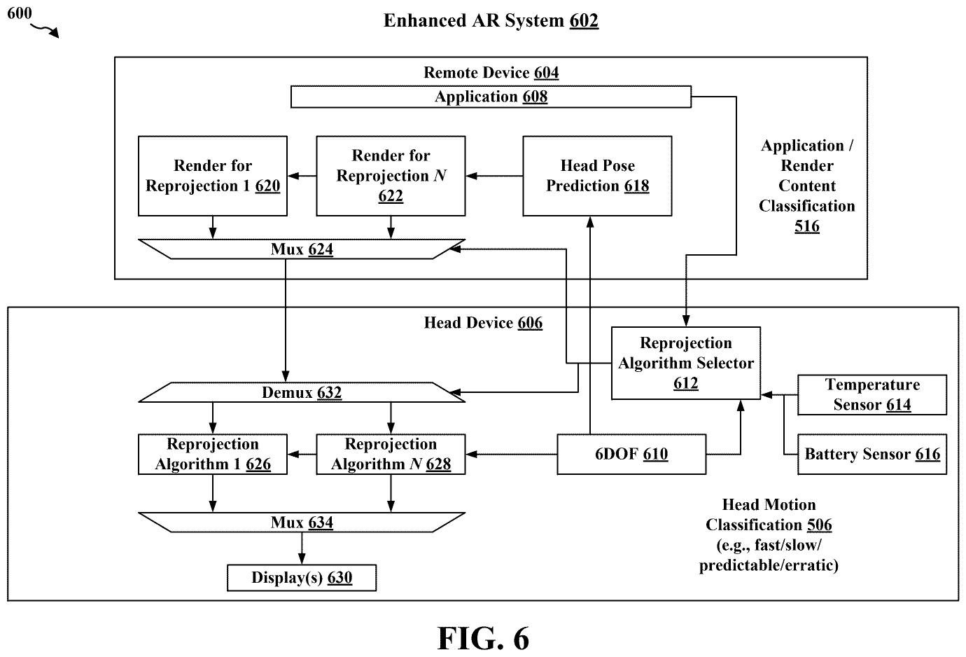

FIG. 6 is a diagram 600 illustrating an example of an enhanced split AR system 602 in accordance with one or more techniques of this disclosure. As discussed in greater detail below, the enhanced split AR system 602 may be configured to select reprojection algorithm(s) from amongst a plurality of reprojection algorithms based on one or more of the reprojection algorithm selection factors 502. The enhanced split AR system 602 may also be configured to render content (i.e., AR content) based on the reprojection algorithm(s), which are selected based on one or more of the reprojection algorithm selection factors 502. The enhanced split AR system 602 may be associated with lower battery consumption and reduced computational workloads in comparison to the split AR system 402.

The enhanced split AR system 602 may include a remote device 604 and a head device 606. In an example, the remote device 404 may be or include phone(s), such as smartphone(s), tablet(s), desktop computing device(s), laptop computing device(s), server(s), such as cloud servers, and/or gaming console(s). In an example, the head device 606 may be a head mounted device (HMD) or AR glasses. The remote device 604 and the head device 606 may be connected and may communicate via a wired connection (e.g., universal serial bus (USB)) or a wireless connection (e.g., WLAN, 5G NR, another cellular technology, etc.). In general, the remote device 404 may be configured to (1) render AR content (e.g., frame(s)) based on reprojection algorithm(s) selected by the head device 606 and (2) transmit the AR content to the head device 606. In general, the head device 606 may be configured to (1) select reprojection algorithm(s) from amongst a plurality of reprojection algorithms, (2) transmit an indication of the selected reprojection algorithm(s) to the remote device 604, (3) receive rendered AR content from the remote device 604, (4) execute the selected reprojection algorithms on the rendered AR content, and (5) present the reprojected rendered AR content on display(s). In one aspect, the head device 606 may include a first display and a second display. When the head device 606 is worn by a user, the first display and the second display may be located within several centimeters of a first eye of the user and a second eye of the user, respectively. The head device 606 may present first processed rendered content on the first display concurrently (or nearly concurrently) with presenting second processed rendered content on the second display, where the first processed rendered content may be viewed by the first eye and the second processed rendered content may be viewed by the second eye. In an example, when viewed by the user, the first processed rendered content and the second processed rendered content may be perceived to be an object present in an environment of the user. In an example, the remote device 604 may be the device 104. In another example, the head device 606 may be the device 104.

The remote device 604 may include an application 608. In an example, the application 608 may be an AR application configured to render AR content. The head device 606 may include a light-weight application corresponding to the application 608, where the light-weight application may be configured to perform a lesser amount of processing in comparison to an amount of processing performed by the application due to limited processing capabilities of the head device 606.

The head device 606 may obtain pose information 610 (referred to as “6DOF” in FIG. 6) of the head device 606. The pose information 610 may include a current location (e.g., an xyz coordinate) and orientation (e.g., a roll, a pitch, and a yaw) of the head device 606 (and hence, a head of a user of the head device 606). In an example, the head device 606 may obtain the pose information 610 by way of an inertial measurement unit (IMU) of the head device 606. The head device 606 may transmit the pose information to the remote device 604. The head device 606 may also transmit additional information to the remote device 604, such as camera images captured by a camera of the head device 606, input by a user of the head device 606, a state of the light-weight application, etc.

The head device 606 may include a reprojection algorithm selector 612. The reprojection algorithm selector 612 may be configured to select reprojection algorithm(s) from amongst a plurality of reprojection algorithms based on one or more of the reprojection algorithm selection factors 502. The reprojection algorithm selector 612 may be implemented in hardware and/or software. In general, the reprojection algorithm selector 612 may be configured to obtain a reprojection algorithm selection factor in the reprojection algorithm selection factors 502 by one or more of (1) receiving the reprojection algorithm selection factor (or an indication thereof) from the remote device 604, (2) determining the reprojection algorithm selection factor based on data from the remote device 604 and/or the head device 606, or (3) receiving the reprojection algorithm selection factor (or an indication thereof) from a component of the head device 606.

In one example, the reprojection algorithm selector 612 may obtain the temperature of the head device 508 based on output of a temperature sensor 614 of the head device 606.

In another example, the reprojection algorithm selector 612 may obtain the battery life of the head device 510 based on output of a battery sensor 616 of the head device 606.

In a further example, the application 608 may determine the application/render content classification 516. The application 608 may transmit the application/render content classification 516 to the head device 606. The reprojection algorithm selector 612 may receive the application/render content classification 516 from the remote device 604.

In yet another example, the reprojection algorithm selector 612 may determine the head motion classification 506 based on the pose information 610 of the head device 606.

After selecting the reprojection algorithm(s) based on one or more of the reprojection algorithm selection factors 502, the reprojection algorithm selector 612 may transmit an indication of the selected reprojection algorithm(s) to the remote device 604.

The remote device 404 may perform a head pose prediction 618 based on the pose information 610, where the head pose prediction 618 is a prediction of a future location and orientation of the head device 606 (and hence, the head of the user of the head device 606).

The remote device 604 may render content (i.e., frame(s)) for the head device 606 based on the indication of the selected reprojection algorithm(s) transmitted by the head device 606. The remote device 604 may also render the content based on the head pose prediction 618, as well as other information such as one or more of the camera images, the input by the user, the state of the light-weight application, a state of the application 608, data from other sources, etc. In an example, the remote device 604 may render content in a first manner (referred to in FIG. 6 as render for reprojection 1 620) when the selected reprojection algorithm is a first reprojection algorithm and the remote device 604 may render the content in an Nth manner (referred to in FIG. 6 as render for reprojection N 622) when the selected reprojection algorithm is an Nth reprojection algorithm, where N is a positive integer greater than one. In an example, rendering the content in the first manner may include rendering the content at a first frame rate and rendering the content in the Nth manner may include rendering the content at a second frame rate, where the first frame rate may be different than the second frame rate. In another example, rendering the content in the first manner may include rendering the content at a first complexity and rendering the content in the Nth manner may include rendering the content at a second complexity, where the first complexity may be different than the second complexity. In one aspect, the remote device 604 may render the content in the first manner or the Nth manner based on output of a multiplexer (referred to in FIG. 6 as mux 624), where the multiplexer takes the indication of the selected reprojection algorithm(s) as input. The remote device 604 may transmit the rendered content to the head device 606.

The head device 606 may receive the rendered content from the remote device 604. The head device 606 may execute the reprojection algorithm selected by the reprojection algorithm selector 612 on the rendered content. The head device 606 may execute the reprojection algorithm based on current pose information of the head device 606. In one example, the selected reprojection algorithm may be a first reprojection algorithm 626 and the head device 606 may execute the first reprojection algorithm 626 on the rendered content. In another example, the selected reprojection algorithm may be an Nth reprojection algorithm 628 and the head device 606 may execute the Nth reprojection algorithm 628 on the rendered content. The head device 406 may output the reprojected rendered content (i.e., reprojected rendered AR content) for display on display(s) 630.

In one aspect, the head device 606 may include a demultiplexer (referred to in FIG. 6 as demux 632) and a multiplexer (referred to in FIG. 6 as mux 634). The demultiplexer and the multiplexer may be used to facilitate the display of reprojected rendered content.

Although not depicted in FIG. 6, the remote device 604 and the head device 606 may include additional components. For instance, the remote device 604 and the head device 606 may each include processor(s), memory, data storage, communication devices (e.g., modems), batteries, buses, input devices, output devices, etc.

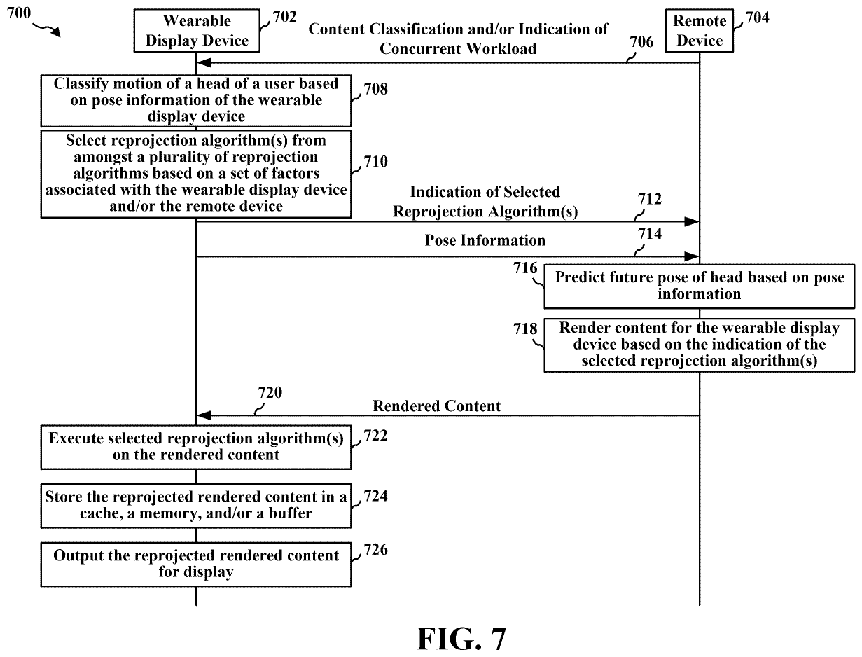

FIG. 7 is a call flow diagram 700 illustrating example communications between a wearable display device 702 and a remote device 704 in accordance with one or more techniques of this disclosure. In an example, the wearable display device 702 may be or include the head device 606 and the remote device 704 may be or include the remote device 604.

At 706, the remote device 704 may transmit a classification of content (e.g., XR content) and/or an indication of an amount of concurrent workloads at the remote device 704. The classification of the content and/or the indication of the amount of concurrent workloads may be transmitted concurrently or separately. At 708, the wearable display device 702 may classify motion of a head of a user based on pose information of the wearable display device 702. For example, the wearable display device 702 may classify the motion as fast or slow. In another example, the wearable display device 702 may classify the motion as predictable or erratic. At 710, the wearable display device 702 may select reprojection algorithm(s) (e.g., asynchronous reprojection, asynchronous timewarp, asynchronous spacewarp, motion smoothing, etc.) from amongst a plurality of reprojection algorithms based on a set of factors (e.g., one or more of the reprojection algorithm selection factors 502) associated with the wearable display device 702 and/or the remote device 704. The set of factors may include the classification of the content and/or the amount of concurrent workloads at the remote device 704.

At 712, the wearable display device 702 may transmit an indication of the selected reprojection algorithm(s) to the remote device 704. At 714, the wearable display device 702 may transmit the pose information to the remote device 704. The indication of the selected reprojection algorithm(s) and/or the pose information may be transmitted concurrently or separately. At 716, the remote device 704 may predict a future pose of a head of a user of the wearable display device 702 based on the pose information. At 718, the remote device may render content for the wearable display device 702 based on the indication of the selected reprojection algorithm(s). The remote device may also render the content based on the predicted future pose of the head of the user.

At 720, the remote device 704 may transmit the rendered content to the wearable display device 702. At 722, the wearable display device 702 may execute the selected reprojection algorithm(s) on the rendered content. At 724, the wearable display device 702 may store the reprojected rendered content in a cache, a memory, and/or a buffer of the wearable display device 702. At 726, the wearable display device 702 may output the reprojected rendered content for display on display panel(s) of the wearable display device 702.

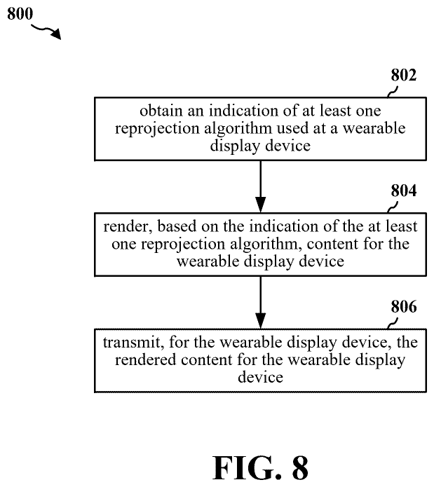

FIG. 8 is a flowchart 800 of an example method of graphics processing in accordance with one or more techniques of this disclosure. The method may be performed by an apparatus, such as a remote device, an apparatus for graphics processing, a GPU, a CPU, a wireless communication device, and the like, as used in connection with the aspects of FIGS. 1-7. In an example, the method may be performed by the remote device 604, the remote device 704, or the device 104. In an example, the method may be performed by the reprojection based renderer 199.

At 802, the apparatus (e.g., a remote device) obtains an indication of at least one reprojection algorithm used at a wearable display device. For example, FIG. 7 at 712 shows that the remote device 704 may obtain an indication of at least one reprojection algorithm used at the wearable display device 702. For example, the at least one reprojection algorithm may be the first reprojection algorithm 626 or the Nth reprojection algorithm 628. In an example, the wearable display device may be the head device 606. In an example, 802 may be performed by the reprojection based renderer 199.

At 804, the apparatus (e.g., a remote device) renders, based on the indication of the at least one reprojection algorithm, content for the wearable display device. For example, FIG. 7 at 718 shows that the remote device 704 may render, based on the indication of the at least one reprojection algorithm, content for the wearable display device 702. For example, rendering the content may be associated with render for reprojection 1 620 or render for reprojection N 622. In an example, 804 may be performed by the reprojection based renderer 199.

At 806, the apparatus (e.g., a remote device) transmits, for the wearable display device, the rendered content for the wearable display device. For example, FIG. 7 at 720 shows that the remote device 704 may transmit, for the wearable display device 702, the rendered content for the wearable display device 702. In an example, 806 may be performed by the reprojection based renderer 199.

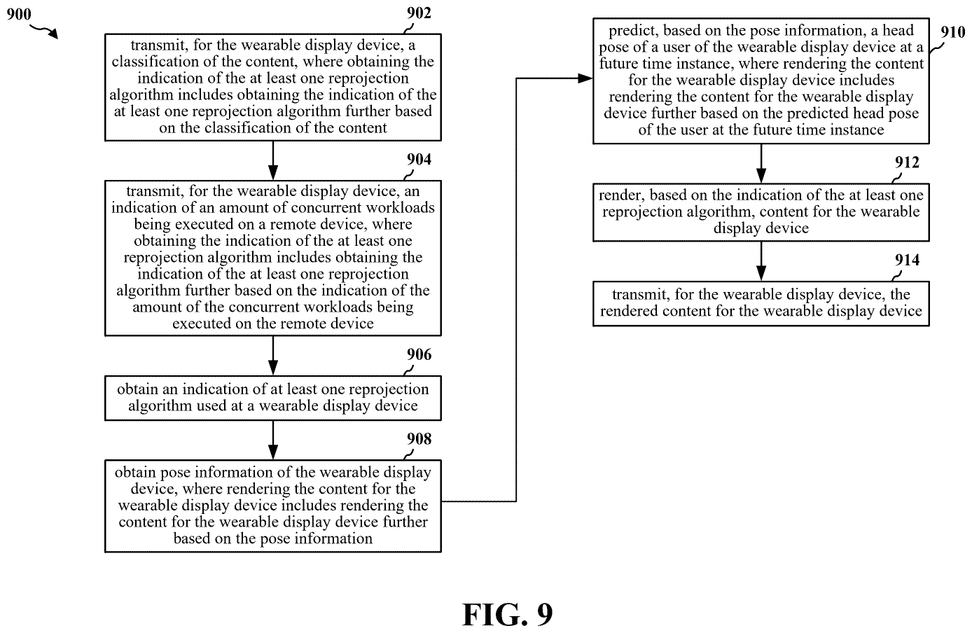

FIG. 9 is a flowchart 900 of an example method of graphics processing in accordance with one or more techniques of this disclosure. The method may be performed by an apparatus, such as a remote device, an apparatus for graphics processing, a GPU, a CPU, a wireless communication device, and the like, as used in connection with the aspects of FIGS. 1-7. In an example, the method may be performed by the remote device 604, the remote device 704, or the device 104. In an example, the method (including the various aspects detailed below) may be performed by the reprojection based renderer 199.

At 906, the apparatus (e.g., a remote device) obtains an indication of at least one reprojection algorithm used at a wearable display device. For example, FIG. 7 at 712 shows that the remote device 704 may obtain an indication of at least one reprojection algorithm used at the wearable display device 702. For example, the at least one reprojection algorithm may be the first reprojection algorithm 626 or the Nth reprojection algorithm 628. In an example, the wearable display device may be the head device 606. In an example, 906 may be performed by the reprojection based renderer 199.

At 912, the apparatus (e.g., a remote device) renders, based on the indication of the at least one reprojection algorithm, content for the wearable display device. For example, FIG. 7 at 718 shows that the remote device 704 may render, based on the indication of the at least one reprojection algorithm, content for the wearable display device 702. For example, rendering the content may be associated with render for reprojection 1 620 or render for reprojection N 622. In an example, 912 may be performed by the reprojection based renderer 199.

At 914, the apparatus (e.g., a remote device) transmits, for the wearable display device, the rendered content for the wearable display device. For example, FIG. 7 at 720 shows that the remote device 704 may transmit, for the wearable display device 702, the rendered content for the wearable display device 702. In an example, 914 may be performed by the reprojection based renderer 199.

In one aspect, at 908, the apparatus (e.g., a remote device) may obtain pose information of the wearable display device, where rendering the content for the wearable display device may include rendering the content for the wearable display device further based on the pose information. For example, FIG. 7 at 714 shows that the remote device 704 may obtain pose information of the wearable display device 702, and rendering the content at 718 may include rendering the content for the wearable display device 702 further based on the pose information. In an example, 908 may be performed by the reprojection based renderer 199.

In one aspect, at 910, the apparatus (e.g., a remote device) may predict, based on the pose information, a head pose of a user of the wearable display device at a future time instance, where rendering the content for the wearable display device may include rendering the content for the wearable display device further based on the predicted head pose of the user at the future time instance. For example, FIG. 7 at 716 shows that the remote device 704 may predict, based on the pose information, a head pose of a user of the wearable display device at a future time instance, and rendering the content at 718 may include rendering the content for the wearable display device 702 further based on the predicted head pose of the user at the future time instance. In an example, 910 may be performed by the reprojection based renderer 199.

In one aspect, the at least one reprojection algorithm may be included in a plurality of reprojection algorithms used at the wearable display device. For example, the plurality of reprojection algorithms used at the wearable display device 702 may include asynchronous reprojection, asynchronous timewarp, asynchronous spacewarp, and motion smoothing.

In one aspect, a first reprojection algorithm in the plurality of reprojection algorithms may be associated with a first battery consumption and a first computational complexity, where a second reprojection algorithm in the plurality of reprojection algorithms may be associated with a second battery consumption and a second computational complexity, and where the first battery consumption is greater than the second battery consumption and the first computational complexity is greater than the second computational complexity. For example, the first reprojection algorithm may be the first reprojection algorithm 626 and the second reprojection algorithm may be the Nth reprojection algorithm 628.

In one aspect, at 902, the apparatus (e.g., a remote device) may transmit, for the wearable display device, a classification of the content, where obtaining the indication of the at least one reprojection algorithm may include obtaining the indication of the at least one reprojection algorithm further based on the classification of the content. For example, FIG. 7 at 706 shows that the remote device 704 may transmit a classification of the content for the wearable display device 702, and obtaining the indication of the at least one reprojection algorithm at 712 may be based on the classification of the content. In an example, the classification of the content may include aspects described above in connection with the application/render content classification 516. In an example, 902 may be performed by the reprojection based renderer 199.

In one aspect, at 904, the apparatus (e.g., a remote device) may transmit, for the wearable display device, an indication of an amount of concurrent workloads being executed on a remote device, where obtaining the indication of the at least one reprojection algorithm may include obtaining the indication of the at least one reprojection algorithm further based on the indication of the amount of the concurrent workloads being executed on the remote device. For example, FIG. 7 at 706 shows that the remote device 704 may transmit an indication of an amount of concurrent workloads being executed on a remote device 704, and obtaining the indication of the at least one reprojection algorithm at 712 may be based on the indication of the amount of concurrent workloads being executed on a remote device 704. In an example, the indication of the amount of concurrent workloads may include aspects described above in connection with the amount of concurrent workloads executed at the remote device 518. In an example, 904 may be performed by the reprojection based renderer 199.

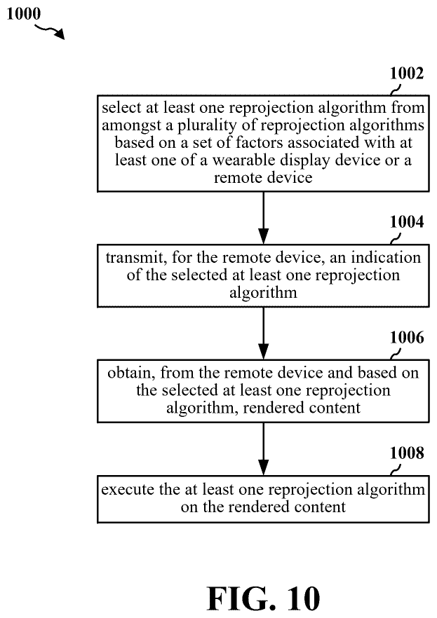

FIG. 10 is a flowchart 1000 of an example method of display processing in accordance with one or more techniques of this disclosure. The method may be performed by an apparatus, such as a wearable display device, an apparatus for display processing, a CPU, a display processing unit (DPU) or other display processor, a wireless communication device, and the like, as used in connection with the aspects of FIGS. 1-7. In an example, the method may be performed by the head device 606, the wearable display device 702, or the device 104. In an example, the method may be performed by the reprojection algorithm selector 198.

At 1002, the apparatus (e.g., a wearable display device) selects at least one reprojection algorithm from amongst a plurality of reprojection algorithms based on a set of factors associated with at least one of a wearable display device or a remote device. For example, FIG. 7 at 710 shows that the wearable display device 702 may select at least one reprojection algorithm from amongst a plurality of reprojection algorithms based on a set of factors associated with at least one of the wearable display device 702 or a remote device 704. In an example, the set of factors may be or include the reprojection algorithm selection factors 502. In an example, the plurality of reprojection algorithms may include asynchronous reprojection, asynchronous timewarp, asynchronous spacewarp, and motion smoothing. In an example, the remote device may be or include the remote device 604. In an example, 1002 may be performed by the reprojection algorithm selector 198.

At 1004, the apparatus (e.g., a wearable display device) transmits, for the remote device, an indication of the selected at least one reprojection algorithm. For example, FIG. 7 at 712 shows that the wearable display device 702 may transmit an indication of the selected at least one reprojection algorithm. In an example, 1004 may be performed by the reprojection algorithm selector 198.

At 1006, the apparatus (e.g., a wearable display device) obtains, from the remote device and based on the selected at least one reprojection algorithm, rendered content. For example, FIG. 7 at 720 shows that the wearable display device 702 may obtain rendered content from the remote device 704 based on the selected at least one reprojection algorithm. In an example, 1006 may be performed by the reprojection algorithm selector 198.

At 1008, the apparatus (e.g., a wearable display device) executes the at least one reprojection algorithm on the rendered content. For example, FIG. 7 at 722 shows that the wearable display device 702 may execute the at least one reprojection algorithm on the rendered content. In an example, 1008 may be performed by the reprojection algorithm selector 198.

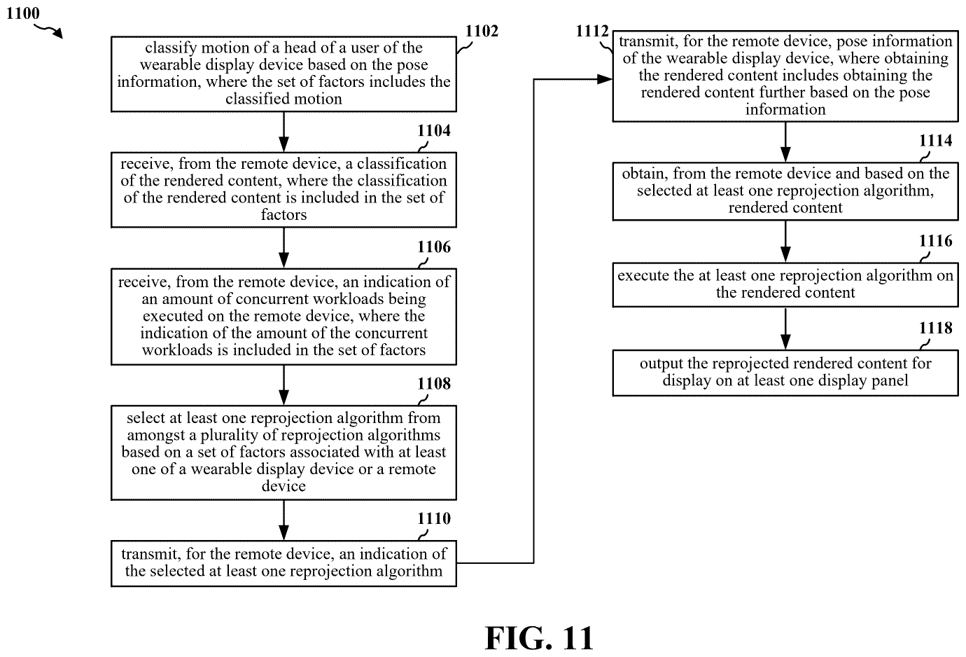

FIG. 11 is a flowchart 1100 of an example method of display processing in accordance with one or more techniques of this disclosure. The method may be performed by an apparatus, such as a wearable display device, an apparatus for display processing, a CPU, a display processing unit (DPU) or other display processor, a wireless communication device, and the like, as used in connection with the aspects of FIGS. 1-7. In an example, the method may be performed by the head device 606, the wearable display device 702, or the device 104. In an example, the method may be performed by the reprojection algorithm selector 198.

At 1108, the apparatus (e.g., a wearable display device) selects at least one reprojection algorithm from amongst a plurality of reprojection algorithms based on a set of factors associated with at least one of a wearable display device or a remote device. For example, FIG. 7 at 710 shows that the wearable display device 702 may select at least one reprojection algorithm from amongst a plurality of reprojection algorithms based on a set of factors associated with at least one of the wearable display device 702 or a remote device 704. In an example, the set of factors may be or include the reprojection algorithm selection factors 502. In an example, the plurality of reprojection algorithms may include asynchronous reprojection, asynchronous timewarp, asynchronous spacewarp, and motion smoothing. In an example, the remote device may be or include the remote device 604. In an example, 1108 may be performed by the reprojection algorithm selector 198.

At 1110, the apparatus (e.g., a wearable display device) transmits, for the remote device, an indication of the selected at least one reprojection algorithm. For example, FIG. 7 at 712 shows that the wearable display device 702 may transmit an indication of the selected at least one reprojection algorithm. In an example, 1110 may be performed by the reprojection algorithm selector 198.

At 1114, the apparatus (e.g., a wearable display device) obtains, from the remote device and based on the selected at least one reprojection algorithm, rendered content. For example, FIG. 7 at 720 shows that the wearable display device 702 may obtain rendered content from the remote device 704 based on the selected at least one reprojection algorithm. In an example, 1114 may be performed by the reprojection algorithm selector 198.

At 1116, the apparatus (e.g., a wearable display device) executes the at least one reprojection algorithm on the rendered content. For example, FIG. 7 at 722 shows that the wearable display device 702 may execute the at least one reprojection algorithm on the rendered content. In an example, 1116 may be performed by the reprojection algorithm selector 198.

In one aspect, at 1112, the apparatus (e.g., a wearable display device) may transmit, for the remote device, pose information of the wearable display device, where obtaining the rendered content includes obtaining the rendered content further based on the pose information. For example, FIG. 7 at 714 shows that the wearable display device 702 may transmit pose information of the wearable display device 702, and obtaining the rendered content at 720 may be based on the pose information. In an example, 1112 may be performed by the reprojection algorithm selector 198.

In one aspect, at 1102, the apparatus (e.g., a wearable display device) may classify motion of a head of a user of the wearable display device based on the pose information, where the set of factors includes the classified motion. For example, FIG. 7 at 708 shows that the wearable display device 702 may classify motion of a head of a user of the wearable display device based on the pose information, where the set of factors may include the classified motion. In an example, classifying the motion of the head of the user may include may include aspects described above in connection with the head motion classification 506. In an example, 1102 may be performed by the reprojection algorithm selector 198.

In one aspect, the set of factors may include an expected motion-to-render-to-display latency of the wearable display device. For example, the aforementioned aspect may be associated with the expected motion-to-render-to-display latency 504.

In one aspect, the set of factors may include at least one of a temperature of the wearable display device or a battery level of the wearable display device. For example, the aforementioned aspect may be associated with the temperature of the head device 508 or the battery level of the head device 510.

In one aspect, at 1104, the apparatus may receive, from the remote device, a classification of the rendered content, where the classification of the rendered content is included in the set of factors. For example, FIG. 7 at 706 shows that the wearable display device 702 may receive a classification of rendered content. For example, the aforementioned aspect may be associated with the application/render content classification 516. In an example, 1104 may be performed by the reprojection algorithm selector 198.

In one aspect, at 1106, the apparatus (e.g., a wearable display device) may receive, from the remote device, an indication of an amount of concurrent workloads being executed on the remote device, where the indication of the amount of the concurrent workloads is included in the set of factors. For example, FIG. 7 at 706 shows that the wearable display device 702 may receive an indication of an amount of concurrent workloads being executed on the remote device 704. In an example, the aforementioned aspect may be associated with the amount of concurrent workloads at the remote device 518. In an example, 1106 may be performed by the reprojection algorithm selector 198.

In one aspect, the set of factors may include a sensitivity of content to reprojection error. For example, the aforementioned aspect may be associated with the sensitivity of content to reprojection error 512.

In one aspect, the set of factors may include a time period before a next display synchronization at the wearable display device. For example, the aforementioned aspect may correspond to the time before a next display synchronization 514.

In one aspect, a first reprojection algorithm in the plurality of reprojection algorithms may be associated with a first battery consumption and a first computational complexity, where a second reprojection algorithm in the plurality of reprojection algorithms may be associated with a second battery consumption and a second computational complexity, and where the first battery consumption is greater than the second battery consumption and the first computational complexity is greater than the second computational complexity. For example, the first reprojection algorithm may be the first reprojection algorithm 626 and the second reprojection algorithm may be the Nth reprojection algorithm 628.

In one aspect, executing the at least one reprojection algorithm on the rendered content may produce reprojected rendered content, and at 1118, the apparatus (e.g., a wearable display device) may output the reprojected rendered content for display on at least one display panel. For example, FIG. 7 at 726 shows that the wearable display device 702 may output the reprojected rendered content for display on at least one display panel (e.g., on the display(s) 131). In an example, 1118 may be performed by the reprojection algorithm selector 198.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus (e.g., the processing unit 120) may include means for obtaining an indication of at least one reprojection algorithm used at a wearable display device. The apparatus (e.g., the processing unit 120) may further include means rendering, based on the indication of the at least one reprojection algorithm, content for the wearable display device. The apparatus (e.g., the processing unit 120) may further include means for transmitting, for the wearable display device, the rendered content for the wearable display device. The apparatus (e.g., the processing unit 120) may further include means for obtaining pose information of the wearable display device, where rendering the content for the wearable display device includes rendering the content for the wearable display device further based on the pose information. The apparatus (e.g., the processing unit 120) may further include means for predicting, based on the pose information, a head pose of a user of the wearable display device at a future time instance, where rendering the content for the wearable display device includes rendering the content for the wearable display device further based on the predicted head pose of the user at the future time instance. The apparatus (e.g., the processing unit 120) may further include means for transmitting, for the wearable display device, a classification of the content, where obtaining the indication of the at least one reprojection algorithm includes obtaining the indication of the at least one reprojection algorithm further based on the classification of the content. The apparatus (e.g., the processing unit 120) may further include means for transmitting, for the wearable display device, an indication of an amount of concurrent workloads being executed on a remote device, where obtaining the indication of the at least one reprojection algorithm includes obtaining the indication of the at least one reprojection algorithm further based on the indication of the amount of the concurrent workloads being executed on the remote device.

In configurations, a method or an apparatus for display processing is provided. The apparatus may be a DPU, a display processor, or some other processor that may perform display processing. In aspects, the apparatus may be the display processor 127 within the device 104, or may be some other hardware within the device 104 or another device. The apparatus (e.g., the display processor 127) may include means for selecting at least one reprojection algorithm from amongst a plurality of reprojection algorithms based on a set of factors associated with at least one of a wearable display device or a remote device. The apparatus (e.g., the display processor 127) may further include means for transmitting, for the remote device, an indication of the selected at least one reprojection algorithm. The apparatus (e.g., the display processor 127) may further include means for obtaining, from the remote device and based on the selected at least one reprojection algorithm, rendered content. The apparatus (e.g., the display processor 127) may further include means for executing the at least one reprojection algorithm on the rendered content. The apparatus (e.g., the display processor 127) may further include means for transmitting, for the remote device, pose information of the wearable display device, where obtaining the rendered content includes obtaining the rendered content further based on the pose information. The apparatus (e.g., the display processor 127) may further include means for classifying motion of a head of a user of the wearable display device based on the pose information, where the set of factors includes the classified motion. The apparatus (e.g., the display processor 127) may further include means for receiving, from the remote device, a classification of the rendered content, where the classification of the rendered content is included in the set of factors. The apparatus (e.g., the display processor 127) may further include means for receiving, from the remote device, an indication of an amount of concurrent workloads being executed on the remote device, where the indication of the amount of the concurrent workloads is included in the set of factors. The apparatus (e.g., the display processor 127) may further include means for outputting the reprojected rendered content for display on at least one display panel.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 a method of graphics processing, comprising: obtaining an indication of at least one reprojection algorithm used at a wearable display device; rendering, based on the indication of the at least one reprojection algorithm, content for the wearable display device; and transmitting, for the wearable display device, the rendered content for the wearable display device.

Aspect 2 may be combined with aspect 1 and further comprises obtaining pose information of the wearable display device, wherein rendering the content for the wearable display device comprises rendering the content for the wearable display device further based on the pose information.

Aspect 3 may be combined with aspect 2 and further comprises predicting, based on the pose information, a head pose of a user of the wearable display device at a future time instance, wherein rendering the content for the wearable display device comprises rendering the content for the wearable display device further based on the predicted head pose of the user at the future time instance.

Aspect 4 may be combined with any of aspects 1-3 and comprises that the at least one reprojection algorithm is included in a plurality of reprojection algorithms used at the wearable display device.

Aspect 5 may be combined with aspect 4 and comprises that a first reprojection algorithm in the plurality of reprojection algorithms is associated with a first battery consumption and a first computational complexity, wherein a second reprojection algorithm in the plurality of reprojection algorithms is associated with a second battery consumption and a second computational complexity, and wherein the first battery consumption is greater than the second battery consumption and the first computational complexity is greater than the second computational complexity.

Aspect 6 may be combined with any of aspects 1-5 and further comprises transmitting, for the wearable display device, a classification of the content, wherein obtaining the indication of the at least one reprojection algorithm comprises obtaining the indication of the at least one reprojection algorithm further based on the classification of the content.

Aspect 7 may be combined with any of aspects 1-6 and further comprises transmitting, for the wearable display device, an indication of an amount of concurrent workloads being executed on a remote device, wherein obtaining the indication of the at least one reprojection algorithm comprises obtaining the indication of the at least one reprojection algorithm further based on the indication of the amount of the concurrent workloads being executed on the remote device.

Aspect 8 is an apparatus for graphics processing comprising a processor coupled a memory, and based on information stored in the memory, the processor is configured to implement a method as in any of aspects 1-7.

Aspect 9 may be combined with aspect 8 and comprises that the apparatus is a wireless communication device comprising at least one of a transceiver or an antenna coupled to the processor, wherein to transmit the rendered content, the processor is configured to transmit the rendered content via at least one of the transceiver or the antenna.

Aspect 10 is an apparatus for graphics processing comprising means for implementing a method as in any of aspects 1-7.

Aspect 11 is a computer-readable medium (e.g., a non-transitory computer-readable medium) storing computer executable code, the computer executable code when executed by a processor causes the processor to implement a method as in any of aspects 1-7.

Aspect 12 is a method of display processing, comprising: selecting at least one reprojection algorithm from amongst a plurality of reprojection algorithms based on a set of factors associated with at least one of a wearable display device or a remote device; transmitting, for the remote device, an indication of the selected at least one reprojection algorithm; obtaining, from the remote device and based on the selected at least one reprojection algorithm, rendered content; and executing the at least one reprojection algorithm on the rendered content.

Aspect 13 may be combined with aspect 12 and further comprises transmitting, for the remote device, pose information of the wearable display device, wherein obtaining the rendered content comprises obtaining the rendered content further based on the pose information.

Aspect 14 may be combined with any of aspects 12-13 and further comprises classifying motion of a head of a user of the wearable display device based on the pose information, wherein the set of factors comprises the classified motion.

Aspect 15 may be combined with any of aspects 12-14 and comprises that the set of factors comprises an expected motion-to-render-to-display latency of the wearable display device.

Aspect 16 may be combined with any of aspects 12-15 and comprises that the set of factors comprises at least one of a temperature of the wearable display device or a battery level of the wearable display device.

Aspect 17 may be combined with any of aspects 12-16 and further comprises receiving, from the remote device, a classification of the rendered content, wherein the classification of the rendered content is included in the set of factors.

Aspect 18 may be combined with any of aspects 12-17 and further comprises receiving, from the remote device, an indication of an amount of concurrent workloads being executed on the remote device, wherein the indication of the amount of the concurrent workloads is included in the set of factors.

Aspect 19 may be combined with any of aspects 12-18 and comprises that the set of factors comprises a sensitivity of content to reprojection error.

Aspect 20 may be combined with any of aspects 12-19 and comprises that the set of factors comprises a time period before a next display synchronization at the wearable display device.

Aspect 21 may be combined with any of aspects 12-20 and comprises that a first reprojection algorithm in the plurality of reprojection algorithms is associated with a first battery consumption and a first computational complexity, wherein a second reprojection algorithm in the plurality of reprojection algorithms is associated with a second battery consumption and a second computational complexity, and wherein the first battery consumption is greater than the second battery consumption and the first computational complexity is greater than the second computational complexity.

Aspect 22 may be combined with any of aspects 12-21 and comprises that executing the at least one reprojection algorithm on the rendered content produces reprojected rendered content, further comprising: outputting the reprojected rendered content for display on at least one display panel.

Aspect 23 is an apparatus for display processing comprising a processor coupled to a memory, and based on information stored in the memory, the processor is configured to implement a method as in any of aspects 12-22.

Aspect 24 may be combined with aspect 23 and comprises that the apparatus is a wireless communication device comprising at least one of a transceiver or an antenna coupled to the processor, wherein to transmit the indication of the selected at least one reprojection algorithm, the processor is configured to transmit the indication of the selected at least one reprojection algorithm via at least one of the transceiver or the antenna.

Aspect 25 is an apparatus for display processing comprising means for implementing a method as in any of aspects 12-22.

Aspect 26 is a computer-readable medium (e.g., a non-transitory computer-readable medium) storing computer executable code, the computer executable code when executed by a processor causes the processor to implement a method as in any of aspects 12-22.

Various aspects have been described herein. These and other aspects are within the scope of the following claims.

1. An apparatus for graphics processing, comprising:
a memory; and
a processor coupled to the memory and, based on information stored in the memory, the processor is configured to:
obtain an indication of at least one reprojection algorithm used at a wearable display device;
render, based on the indication of the at least one reprojection algorithm, content for the wearable display device; and
transmit, for the wearable display device, the rendered content for the wearable display device.

2. The apparatus of claim 1, wherein the processor is further configured to:
obtain pose information of the wearable display device, wherein to render the content for the wearable display device, the processor is configured to render the content for the wearable display device further based on the pose information.

3. The apparatus of claim 2, wherein the processor is further configured to:
predict, based on the pose information, a head pose of a user of the wearable display device at a future time instance, wherein to render the content for the wearable display device, the processor is configured to render the content for the wearable display device further based on the predicted head pose of the user at the future time instance.

4. The apparatus of claim 1, wherein the at least one reprojection algorithm is included in a plurality of reprojection algorithms used at the wearable display device.

5. The apparatus of claim 4, wherein a first reprojection algorithm in the plurality of reprojection algorithms is associated with a first battery consumption and a first computational complexity, wherein a second reprojection algorithm in the plurality of reprojection algorithms is associated with a second battery consumption and a second computational complexity, and wherein the first battery consumption is greater than the second battery consumption and the first computational complexity is greater than the second computational complexity.

6. The apparatus of claim 1, wherein the processor is further configured to:
transmit, for the wearable display device, a classification of the content, wherein to obtain the indication of the at least one reprojection algorithm, the processor is configured to obtain the indication of the at least one reprojection algorithm further based on the classification of the content.

7. The apparatus of claim 1, wherein the processor is further configured to:
transmit, for the wearable display device, an indication of an amount of concurrent workloads being executed on a remote device, wherein to obtain the indication of the at least one reprojection algorithm, the processor is configured to obtain the indication of the at least one reprojection algorithm further based on the indication of the amount of the concurrent workloads being executed on the remote device.

8. The apparatus of claim 1, wherein the apparatus is a wireless communication device comprising at least one of a transceiver or an antenna coupled to the processor, wherein to transmit the rendered content, the processor is configured to transmit the rendered content via at least one of the transceiver or the antenna.

9. An apparatus for display processing, comprising:
a memory; and
a processor coupled to the memory and, based on information stored in the memory, the processor is configured to:
select at least one reprojection algorithm from amongst a plurality of reprojection algorithms based on a set of factors associated with at least one of a wearable display device or a remote device;
transmit, for the remote device, an indication of the selected at least one reprojection algorithm;
obtain, from the remote device and based on the selected at least one reprojection algorithm, rendered content; and
execute the at least one reprojection algorithm on the rendered content.

10. The apparatus of claim 9, wherein the processor is further configured to:
transmit, for the remote device, pose information of the wearable display device, wherein to obtain the rendered content, the processor is configured to obtain the rendered content further based on the pose information.

11. The apparatus of claim 10, wherein the processor is further configured to:
classify motion of a head of a user of the wearable display device based on the pose information, wherein the set of factors includes the classified motion.

12. The apparatus of claim 9, wherein the set of factors includes an expected motion-to-render-to-display latency of the wearable display device.

13. The apparatus of claim 9, wherein the set of factors includes at least one of a temperature of the wearable display device or a battery level of the wearable display device.

14. The apparatus of claim 9, wherein the processor is further configured to:
receive, from the remote device, a classification of the rendered content, wherein the classification of the rendered content is included in the set of factors.

15. The apparatus of claim 9, wherein the processor is further configured to:
receive, from the remote device, an indication of an amount of concurrent workloads being executed on the remote device, wherein the indication of the amount of the concurrent workloads is included in the set of factors.

16. The apparatus of claim 9, wherein the set of factors includes a sensitivity of content to reprojection error.

17. The apparatus of claim 9, wherein the set of factors includes a time period before a next display synchronization at the wearable display device.

18. The apparatus of claim 9, wherein a first reprojection algorithm in the plurality of reprojection algorithms is associated with a first battery consumption and a first computational complexity, wherein a second reprojection algorithm in the plurality of reprojection algorithms is associated with a second battery consumption and a second computational complexity, and wherein the first battery consumption is greater than the second battery consumption and the first computational complexity is greater than the second computational complexity.

19. The apparatus of claim 9, wherein the apparatus is a wireless communication device comprising at least one of a transceiver or an antenna coupled to the processor, wherein to transmit the indication of the selected at least one reprojection algorithm, the processor is configured to transmit the indication of the selected at least one reprojection algorithm via at least one of the transceiver or the antenna and wherein to execute the at least one reprojection algorithm on the rendered content, the processor is configured to produce reprojected rendered content, wherein the processor is further configured to:
output the reprojected rendered content for display on at least one display panel.

20. (canceled)

21. A method of graphics processing, comprising:
obtaining an indication of at least one reprojection algorithm used at a wearable display device;
rendering, based on the indication of the at least one reprojection algorithm, content for the wearable display device; and
transmitting, for the wearable display device, the rendered content for the wearable display device.

22.-30. (canceled)
